(19) United States
(12) Patent Application Publication
(10) Pub. No.: US 2026/0093782 A1
(43) Pub. Date: Apr. 2, 2026

(54) ANOMALY DETECTION-AIDED AI CLASSIFIER TRAINING

(71) Applicant: SAP SE, Walldorf (DE)

(72) Inventors: Ravikiran Vidhyaranya KRISHNAPRASAD, Bangalore (IN); Karthik Gokare SOMASHEKHAR, Bangalore (IN)

(21) Appl. No.: 18/903,764

(22) Filed: Oct. 1, 2024

(51) Int. Cl. G06F 18/241; G06N 20/00

(52) U.S. Cl. CPC G06F 18/241; G06N 20/00

(57) ABSTRACT

Systems and methods include use of anomaly detection rules may be initially used to detect anomalies in received data instances and to label the instances as anomalous or not anomalous. Once a sufficiently-large set of labeled data instances is available, the labeled data instances are used to train a classification model. The trained classification model and the anomaly detection rules are used to label received data instances as anomalous or not anomalous. The model is re-trained periodically using received labeled data instances until its performance exceeds a threshold. At this point, the trained model only is used to label subsequently-received data instances the instances as anomalous or not anomalous.

### BACKGROUND

Modern system landscapes generate vast amounts of data. The data may include operational data generated during an organization's operations and monitoring data indicative of the health of and load on hardware and software components of the landscape. Anomalies within this data may indicate issues within the landscape. For example, an anomaly in monitoring data may indicate the impending failure of a hardware component, and an anomaly in operational data may indicate the existence of fraud or another type of attack on the organization.

It is therefore desirable to efficiently detect data anomalies within a system landscape. Traditional detection methods rely on manual data evaluation and static rules. These methods have been rendered obsolete by the volume and complexity of data in modern systems and by the sophistication and ongoing evolution of system attack vectors. Any detected anomalies may be inaccurate and/or meaningless, requiring time-consuming manual reviews that increase operational costs and may obscure actual incidents of concern.

Theoretically, anomaly detection may benefit from the use of a trained classification model. However, due to the complexity of this task, a vast amount of labeled data is required to train a classification model to achieve the desired model performance. Labeling large data sets is expensive and requires expert knowledge. Expending such resources on labeling is not acceptable in most organizations.

Systems are desired to efficiently improve anomaly detection within a computing system landscape.

### BRIEF DESCRIPTION OF THE DRAWINGS

FIG. 1 illustrates a system using anomaly detection to assist training of a classification model according to some embodiments.

FIG. 2 is a flow diagram of a process using anomaly detection to assist training of a classification model according to some embodiments.

FIG. 3 is a tabular representation of data instances according to some embodiments.

FIG. 4 illustrates determination of anomaly detection policies according to some embodiments.

FIG. 5 illustrates determination of anomaly detection policies according to some embodiments.

FIG. 6 is a user interface for presenting and labelling potentially-anomalous data instances according to some embodiments.

FIG. 7 is a user interface for presenting information regarding a potentially-anomalous data instance according to some embodiments.

FIG. 8 is a tabular representation of labelled data instances according to some embodiments.

FIG. 9 is a flow diagram of a process for training and using a classification model according to some embodiments.

FIG. 10 illustrates training of a classification model based on labelled data instances according to some embodiments.

FIG. 11 illustrates evaluation of a trained classification based according to some embodiments.

FIG. 12 illustrates a system to train and use a classification model based on anomaly detection according to some embodiments.

FIG. 13 illustrates a system to train and use a classification model based on anomaly detection according to some embodiments.

FIG. 14 is a block diagram of cloud-based servers of a system to train and use a classification model based on anomaly detection according to some embodiments.

### DETAILED DESCRIPTION

The following description is provided to enable any person in the art to make and use the described embodiments. Various modifications, however, will remain readily-apparent to those in the art.

Some embodiments operate to detect data anomalies through selective use of anomaly detection rules and a trained classification model. Advantageously, some embodiments may reduce resources required for data labeling while providing progressively-improving anomaly detection.

The anomaly detection rules may be initially used to detect anomalies in received data instances and to label the instances as anomalous or not anomalous. Once a sufficiently-large set of labeled data instances is available, the labeled data instances are used to train a classification model. If performance of the trained classification model does not meet a threshold, the anomaly detection rules continue to be used to detect anomalies in received data instances and to label the instances as anomalous or not anomalous.

The model is re-trained periodically using all received labeled data instances until its performance exceeds the threshold. At this point, the trained model is used to detect anomalies in received data instances and to label the instances as anomalous or not anomalous. The anomaly detection rules also continue to be used to detect anomalies in received data instances and to label the instances as anomalous or not anomalous.

Accordingly, each received data instance is associated with one label generated based on the anomaly detection rules and another label generated using the trained classification model. Both of these labels many be used in a final determination of whether a data instance is anomalous or not anomalous. For example, a data instance may be determined to be anomalous if either one of the two labels associated with the data instance indicates that the data instance is anomalous.

During the foregoing simultaneous use of the classification model and the anomaly detection rules, the model continues to be re-trained periodically using the labeled data instances until its performance exceeds a second threshold. Once the performance exceeds the second threshold, some embodiments discontinue use of the anomaly detection rules. The trained model only is therefore used to detect anomalies in subsequently-received data instances and to label the instances.

According to some embodiments, data instances identified as anomalous are forwarded for further processing and data instances idenified as not anomalous are rejected. For example, if the values of a data instance are values of operational metrics of a computer network, anomalous data instances may be passed to a technical support team while data instances which are determined to be not anomalous are ignored.

Conversely, data instances identified as not anomalous may be processed as intended by the provider of the data instance and data instances identified as anomalous may be rejected. For example, if the values of the data instance are values of a requisition, non-anomalous data instances may be passed to a requisition department while data instances which are determined to be anomalous may be returned to their source.

Some embodiments employ user confirmation of anomalous data instances. For example, data instances which are determined to be anomalous at any of the above-described three phases (i.e., based on the anomaly detection rules alone, based on the anomaly detection rules and the classification model, and based on the anomaly detection rules alone) may be presented to a user. The user may then confirm whether the presented data instances are anomalous or not anomalous. The data instances are thereafter processed and also stored for future model training according to the label confirmed by the user.

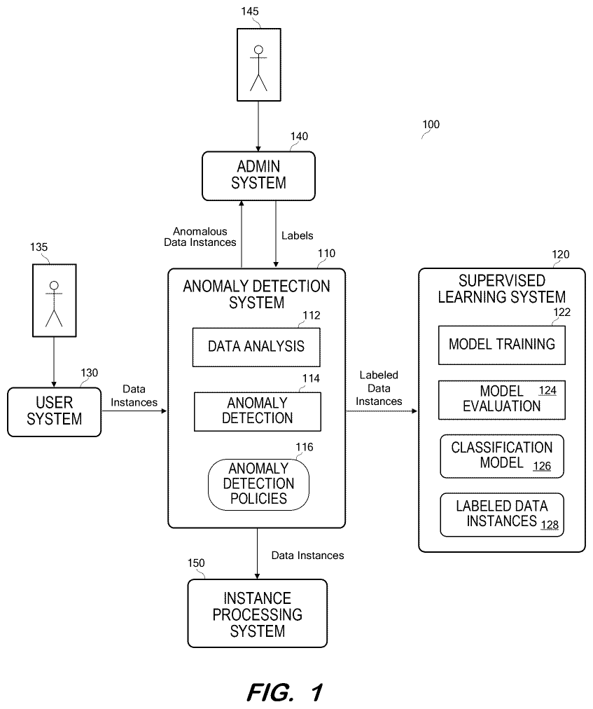

FIG. 1 illustrates system 100 according to some embodiments. The illustrated components of system 100 may be implemented using any suitable combinations of computing hardware and/or software that are or become known. Such combinations may include cloud-based implementations in which computing resources are virtualized and allocated elastically. In some embodiments, two or more components are implemented by a single computing device. System 100 may comprise disparate cloud-based services, a single physical or virtual server, a cluster of physical or virtual servers, several clusters of physical or virtual servers, and any other combination that is or becomes known.

System 100 will be described below with respect to the detection of anomalous data instances. Embodiments are not limited to anomalous/not anomalous classifications.

According to some embodiments, system 100 may operate to classify any type of data instances into any two or more classifications that are or become known.

A data instance according to some embodiments comprises a set of values, where each value is associated with a respective field. The fields, or attributes, may be continuous, categorical, binary, etc. A data instance may be considered anomalous if its values are determined to fall outside a given range of typical or expected values, exhibit one or more characteristics indicative of a technical problem (e.g., system bottleneck or failure) or other issue (e.g., fraud, error, cyber-attack), or are in any other way unsuitable to an organization.

Anomaly detection system 110 detects anomalies associated with data instances. Anomaly detection system 110 includes data analysis component 112, anomaly detection component 114 and anomaly detection policies 116. Data analysis component 112 may analyze received data instances to determine trends, outliers, and other characteristics of the data instances. Data analysis component 112 may perform any suitable pre-processing of the data instances prior to determination of the characteristics thereof. The pre-processing may include filling empty fields, data scaling, data normalization, data aggregation, etc.

The characteristics determined by data analysis component 112 may be used to define anomaly detection policies 116. For example, data analysis component 112 may determine an average number of data instances received during each day of the week. This determination may be used to define a policy 116 which identifies an anomaly if the number of data instances received on a given day of the week is more than 250% of the average number of data instances received during that day of the week. Anomaly detection policies 116 may comprise any suitable policies.

Anomaly detection component 114 applies anomaly detection policies 116 to received data instances in order to determine a classification for each data instance. The determination includes evaluating the values (which may have been pre-processed) of a data instance against anomaly detection policies 116. As mentioned above, the possible classifications of the present example are anomalous/not anomalous. Anomaly detection component 114 labels each data instance with its determined classification. As a result, each received instance is associated with a label of anomalous or not anomalous.

Supervised learning system 120 receives the labeled data instances from system 120 and stores them within labeled data instances 128. Supervised learning system 120 also includes model training component 122, model evaluation component 124 and classification model 126. Model training component 122 executes a supervised learning algorithm to train parameters of classification model 126 to perform a classification task based on labeled data instances 128 as is known in the art. Classification model 126 may confirm to any model architecture that is or becomes known, including but not limited to logistic regression, decision tree, random forest, gradient-boosted tree, multilayer perceptron, one-vs-rest, and Naive Bayes.

Model evaluation component 124 evaluates the performance of a trained classification model 126 based on labeled data instances 128. Preferably, one set of labeled data instances 128 is used to train model 126 and another set of data instances 128 is used to evaluate the performance of (i.e., test) trained model 126. Model evaluation component 124 may determine any one or more performance metrics that are or become known, including but not limited to precision, recall, and F1-score. As described herein, the values of the determined performance metrics may be used to determine an extent to which trained model 126 will be used to detect anomalous data instances.

User system 130 may comprise any device operable by a user such as user 135 to input data instances to anomaly detection system 110. User system 130 may comprise a laptop computer, a desktop computer, a smartphone, a tablet computer, etc. User system 130 may execute a client UI application (not shown) to input data instances to system 110. Such a client UI application may comprise a Web browser or another application (e.g., a front-end UI application which executes within a virtual machine of a Web browser) to provide user interfaces which use APIs to interact with a backend UI application (not shown) executed by system 110.

According to some embodiments, anomaly detection system 110 receives data instances from many user systems operated by many users. For example, anomaly detection system 110 may comprise a single or multi-tenant service for providing anomaly detection to many users.

Administrator system 140 may also comprise a laptop computer, a desktop computer, a smartphone, a tablet computer, etc. Administrator system 140 is operable by user 145 (e.g., a system administrator) to execute an application (not shown) which receives data instances from anomaly detection system 110 and displays the data instances. The received data instances may comprise data instances which have been determined to be anomalous by system 110 and/or system 120. User 145 operates the application to confirm whether or not the displayed instances are anomalous or not anomalous, and to return the corresponding labels to anomaly detection system 110. System 110 may transmit the data instances with their user-confirmed labels to supervised learning system 120 for storage in labeled data instances 128. Accordingly, training and testing of classification model 126 may be performed using the user-confirmed data instance labels.

Anomaly detection system 110 forwards data instances to instance processing system 150. Anomaly detection system 110 forwards data instances determined to be anomalous to instance processing system 150 if instance processing system 150 is intended to process anomalous data instances, and forwards data instances determined to be not anomalous if instance processing system 150 is intended to process non-anomalous data instances. Instance processing system 150 may comprise one or more applications, services, etc. executing one or more virtual and/or physical servers. Instance processing system 150 may provide any suitable functions for processing a data instance provided by a user 135. As non-exhaustive examples, system 150 may comprise a technical support system, an invoice payment system, a data warehousing system, an emergency response system, an ordering system, etc.

As described above, anomaly detection system 110 and supervised learning system 120 may be selectively deployed. For example, only anomaly detection system 110 may be initially deployed to detect anomalies in received data instances based on anomaly detection policies 116. Anomaly detection system 110 provides anomalous data instances to administrator system 140 to confirm whether such instances are anomalous or non-anomalous. Based on anomaly detection policies 116 and instance labels received from administrator system 140, anomaly detection system 110 stores labeled data instances in labeled data instances 128 of system 120.

In the meantime, and once the number of labeled data instances 128 is sufficiently large, model training component 122 trains classification model 126 using a set of labeled data instances 128. Model evaluation component 124 evaluates the performance of trained model 126 based on another set of labeled data instances 128. If the performance of trained classification model 126 does not meet a threshold, anomaly detection system 110 continues to store labeled data instances in labeled data instances 128 as described above.

Model training component 122 re-trains classification model 126 periodically using labeled data instances 128 until its performance exceeds the threshold. Trained model 126 is then used to detect anomalies in received data instances and to label the instances as anomalous or not anomalous, while anomaly detection component 114 continues to detect anomalies in received data instances based on anomaly detection policies 116. In some embodiments, if a data instance is determined as anomalous by either anomaly detection component 114 or trained model 126, the data instance is transmitted to administrator system 140 for confirmation of its classification.

New labeled data instances continue to be collected in labeled data instances 128, including data instances which are determined to be not anomalous by both anomaly detection component 114 and by trained classification model 126, and data instances confirmed as anomalous by administrator system 140. Model 126 continues to be re-trained periodically using labeled data instances 128 until model evaluation component 124 determines that its performance exceeds a second threshold. In response, some embodiments begin to use only trained classification model 128 (and not anomaly detection component 114) to detect anomalies in data instances received from user system 130. Any data instances determined to be anomalous by trained classification model 128 may be confirmed by administrator system 140 as described above.

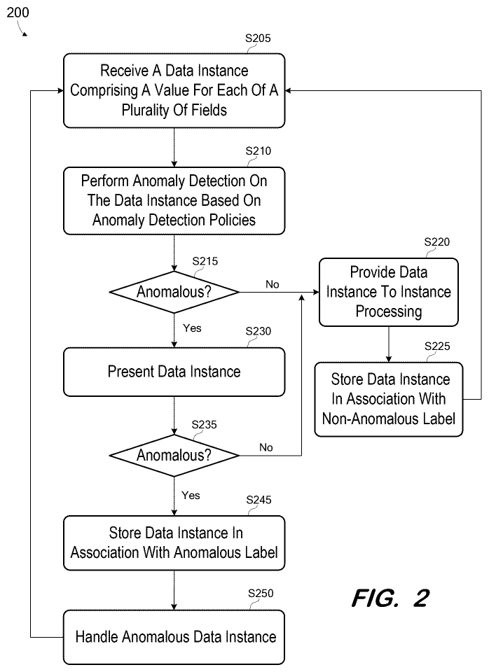

FIG. 2 comprises a flow diagram of a process using anomaly detection to assist training of a classification model according to some embodiments. Process 200 and the other processes described herein may be performed using any suitable combination of hardware and software. Software program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

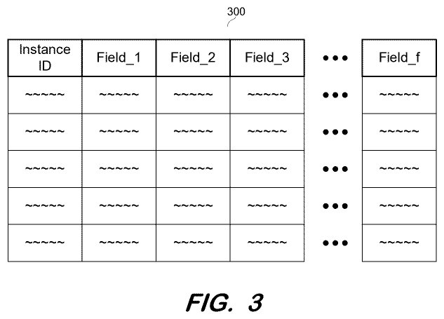

A data instance is initially received at S205. The data instance comprises a value associated with each of a plurality of fields. FIG. 3 is a tabular representation of five data instances 300 according to some embodiments. Each data instance includes the same fields and values (or a missing/NULL value) for each field. A data instance may be received at S205 from an external system such as system 130 operated by a user such as user 135.

Anomaly detection is performed on the data instance at S210. As mentioned above, the received data instance may be pre-processed prior to the performance of anomaly detection thereon. Anomaly detection at S210 is based on anomaly detection policies. The anomaly detection policies may be pre-determined based on characteristics of historical data instances.

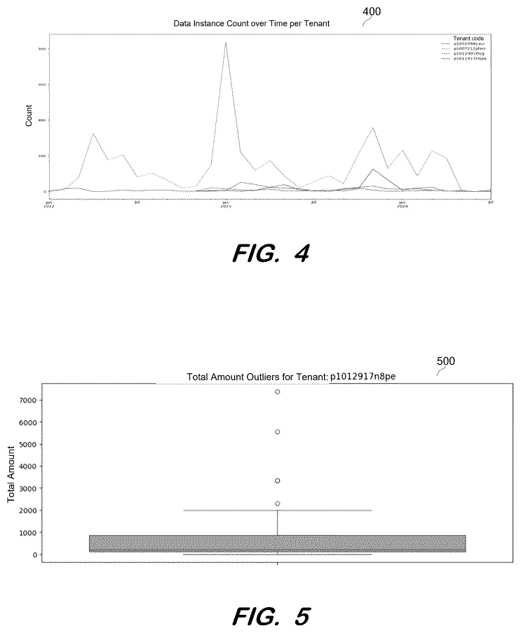

For example, FIGS. 4 and 5 illustrate characteristics of historical data instances according to some embodiments. FIG. 4 shows trend plot 400 of a number of data instances received over time for each of several tenants. FIG. 5, on the other hand, shows box plot 500 for identifying outliers within values of a Total Amount field of historical data instances of a particular tenant. Embodiments are not limited to these examples. Other examples include, non-exhaustively, trend plots of the values of any field, box plots of the values of any field, and a distribution of categories of any categorical field.

The characteristics of the historical data instances may be used to define the anomaly detection policies used at S210. Examples of anomaly detection policies based on characteristics may include, but are not limited to, policies which identify field values greater (or less than) X, more than Y data instances occurring within a given amount of time, certain categorical field values, and particular relationships between field values (e.g., unequal values of two fields). Tenant-specific characteristics may be used to determine tenant-specific anomaly detection policies in some embodiments.

At S215 it is determined whether the received data instance is anomalous, based on the anomaly detection performed at S210. If not, the data instance is provided to a data instance processing system such as system 150 at S220. Also, at S225, the data instance is stored in association with a label indicating that the data instance is not anomalous. The stored labeled data instance will be used for future training of a classification model as described herein. Accordingly, the labeled data instance may be stored at S225 in labeled data instances 128 of supervised learning system 120.

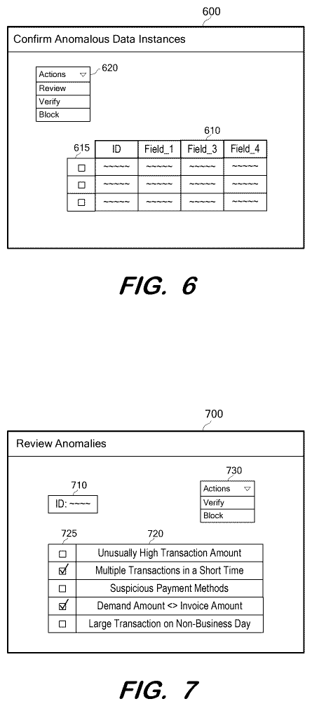

Flow proceeds from S215 to S230 if it is determined at S215 that the received data instance is anomalous. At S230, the data instance is presented to a user. FIG. 6 illustrates user interface 600 of an application according to some embodiments. In one example, a client UI application on administrator system 140 executes a Web browser to access system 110 via HTTP and to render user interface 600 based on data received therefrom.

User interface 600 includes table 610 showing three field values for each of three data instances. The three fields may comprise any subset (or the full set) of fields of the data instances. In the present example, the three data instances have been identified as anomalous by anomaly detection component 114. User interface 600 includes checkboxes 615 to indicate one or more of the instances on which to perform a selected action. Drop-down menu 620 allows selection of one of three actions, Review, Verify and Block.

It will be assumed that the user selects one of checkboxes 615 and the Review action of menu 620, and user interface 700 of FIG. 7 is displayed in response. User interface 700 includes ID 710 of the data instance corresponding to the selected checkbox 615. User interface 700 also includes listing of characteristics 720 which may be exhibited by anomalous data instances. Checkboxes 725 indicate which of characteristics 720 is exhibited by the data instance associated with ID 710.

A user may select Verify within drop-down menu 730 to indicate that the data instance of user interface 700 is not anomalous. Menu 730 also allows selection of Block to confirm that the data instance is anomalous. User interface 600 of FIG. 6 similarly allows selection of Verify or Block, with respect to one or more selected data instances.

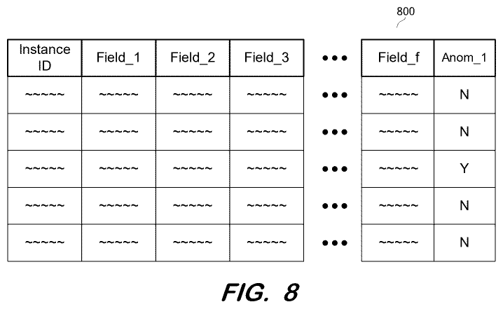

Assuming that Verify has been selected at S230, flow proceeds to S235 and then to S220 and S225 as described above. If the user has confirmed that the data instance is anomalous (e.g., by selecting the Block action), flow proceeds from S235 to S245. At S245, the data instance is stored in association with a label indicating that the data instance is anomalous. The stored labeled data instance will be used for future training of a classification model as described herein. FIG. 8 illustrates labeled data instances 800 which may be stored ay S225 and S245 in some embodiments. Data instances 800 include the same fields as data instances 300 of FIG. 3, plus an additional field for a label (or flag, or value) which indicates whether a data instance is anomalous or not anomalous.

The anomalous data instance is handled at S250. S250 may comprise sending a message to the system from which the data instance was received indicating that the data instance was rejected and will not be processed. In another example, the data instance is sent to a team responsible for handling system anomalies at S250. Flow then returns to S205 to receive a net data instance. Flow cycles between S205 and S250 in this manner until, and if, it is determined to no longer perform anomaly detection on received data instances based on anomaly detection policies.

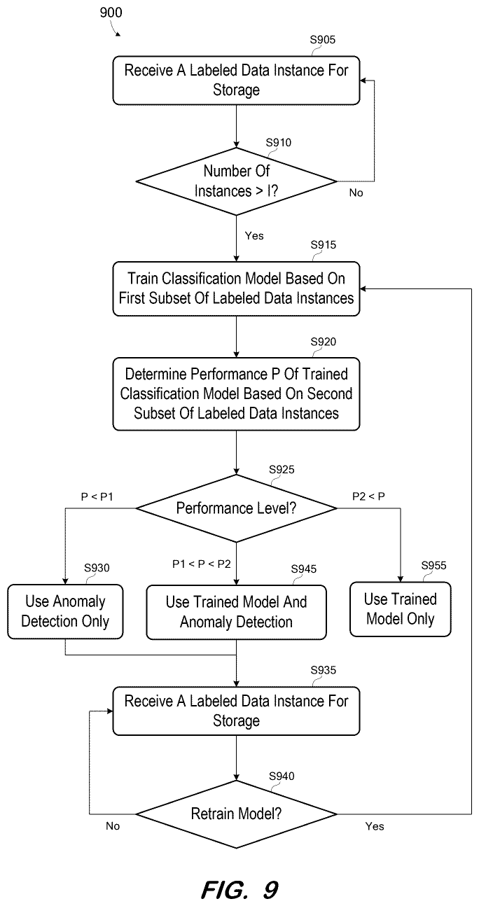

Process 900 of FIG. 9 may be executed by system 100 in some embodiments. For example, at S905, supervised learning system 120 may receive a labeled data instance from anomaly detection system. The labeled data instance may have been transmitted to system 120 for storage at S225 or S245 as described above. The labeled data instance may be labeled to indicate that the data instance is anomalous or is not anomalous, as shown in FIG. 8.

At S910, it is determined whether the number of stored labeled data instances is greater than a first threshold (e.g., I). The first threshold is intended to represent a total number of labeled data instances which are believed to be suitable for training a classification model. The determination at S910 may include evaluation of metrics other than total number of stored labeled data instance, such as but not limited to a type of classification model, a number of anomalous-labeled data instances, a ratio of anomalous-labeled data instances to not anomalous-labeled data instances, etc.

If the number of stored labeled data instances is not greater than the first threshold, flow returns to S905 to receive another labeled data instance for storage. Flow therefore cycles between S905 and S910 until it is determined that a suitable number of labeled data instances are available to train a classification model. During the cycling, anomaly detection system may continue to receive data instances from users and provide labeled data instances for storage as described with respect to process 200. Flow proceeds to S915 once it is determined that a suitable number of stored labeled data instances are available to train a classification model.

The classification model is trained based on a first set of the labeled data instances. As is known in the art, the stored labeled data instances may be split into two sets, one consisting of 70% of the stored labeled data instances and another consisting of 30% of the stored labeled data instances. The ratio of anomalous-labeled data instances to not anomalous-labeled data instances, as well as other characteristics, may be similar between the sets. The larger set of labeled data instances is used for training the model at S915.

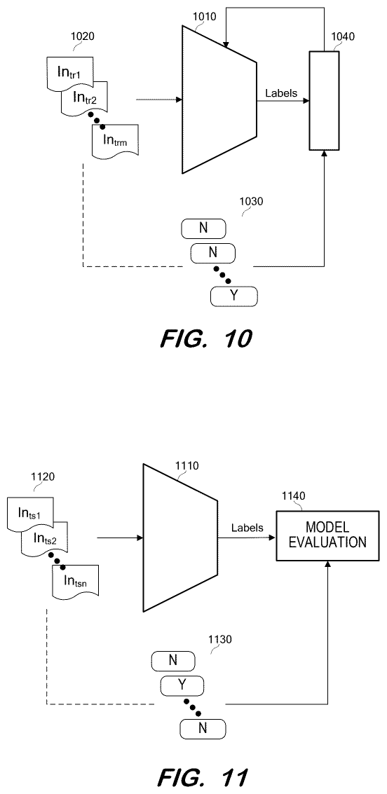

FIG. 10 illustrates the training of a classification model 1010 at S915 according to some embodiments. First set of training data instances 1020 includes M instances (i.e., “Inₜᵣ”). As is known in the art, the contents of each of data instances 1020 might not be identical to the contents of the corresponding data instance received at S905. In this regard, training data instances 1020 may reflect the application of feature engineering techniques to the corresponding received data instances. Such feature engineering techniques may delete fields from the instances, add fields to the instances based on other fields of the instances, etc. Each of training data instances 1020 is associated with a respective label 1030 which is identical to the label stored in association with its corresponding data instance.

During training, a batch of training data instances 1020 is classification model 1010, which outputs a label for each data instance of the batch. Loss layer 1040 compares the output labels to the associated “ground truth” labels 1030 to determine a total loss. The loss is back-propagated to classification model 1010 which is modified based thereon. Training continues in this manner until satisfaction of a given performance target, an elapsed time period, a number of iterations, etc. In some embodiments, classification model 1010 is a decision tree and is trained using the XGBoost or LightGBM libraries.

A performance P of the trained model is determined at S920. The performance P may be determined using a second set of the stored labeled data instances, such as the 30% of data instances described above. FIG. 11 illustrates the evaluation of the performance of trained classification model 1110 at S920 according to some embodiments. Each of N testing data instances (i.e., “Inₜₛ”) 1120 includes the same fields as training data instances 1020 and is associated with a corresponding stored ground truth label 1130.

Determination of performance P may comprise inputting data instances 1120 to trained model 1110 and receiving the resulting output labels at model evaluation component 1140. Component 1140 compares the output labels to ground truth labels 1130 to determine performance P. Performance P may include values of any one or more performance metric, including but not limited to precision, recall and F1-score.

Flow branches at S925 based on the determined performance level. For example, flow proceeds to S930 if the performance level is less than a pre-specified performance level P1. S930 is a determination to use policy-based anomaly detection only, as described with respect to process 200 and illustrated in FIG. 1.

Flow then proceeds to S935 to receive a labeled data instance for storage as described with respect to S905. Flow cycles between S935 and S940 until is it determined at S940 to retrain the classification model. The determination at S940 may be based on a combination of a number data instances stored since a last model training, a time elapsed since a last model training, and other factors. Once it is determined to retrain the classification model, flow returns to S915 and continues as described above.

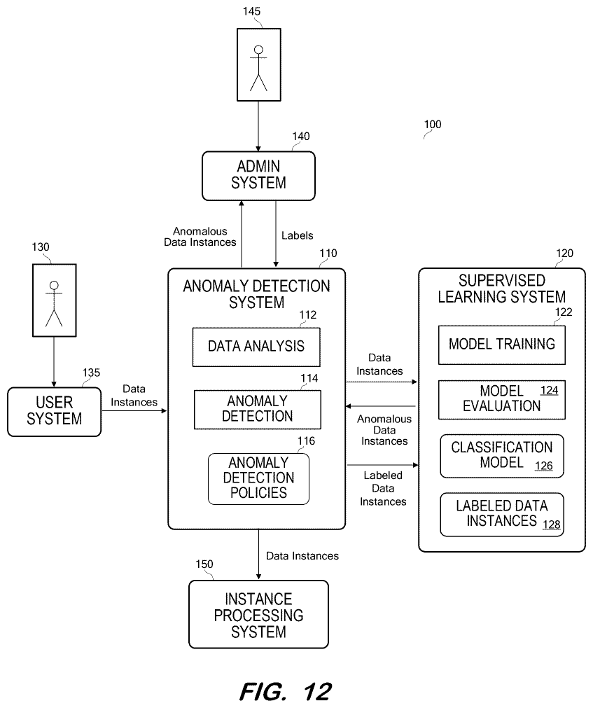

Flow proceeds from S925 to S945 if the performance level is determined to be greater than performance level P1 and less than pre-specified performance level P2. At S945, it is determined to use both policy-based anomaly detection and the trained model. This usage is illustrated in FIG. 12. As shown, anomaly detection system 110 provide data instances received from user system 130 to system 120. System 120 inputs the data instances to trained model 126 to determine whether the data instances are anomalous, and returns the anomalous data instances to system 110.

Anomaly detection component 114 also applies policies to the received data instances to determine whether the data instances are anomalous. Accordingly, anomaly detection component 114 determines a first set of anomalous data instances and trained model 126 determines a second set of anomalous data instances. The data instances of the first set and the second set may be identical, have some common data instances, or have no common data instances.

At S215 of process 200, the determination of whether a data instance is anomalous and should be presented to a user at S230 is based on whether the data instance belongs to the first set or second set of data instances. In some embodiments, a data instance is determined to be anomalous at S215 if anomaly detection component 114 determined that the data instance is anomalous (i.e., the data instance belongs to the first set) or if trained model 126 determined that the data instance is anomalous (i.e., the data instance belongs to the second set). In other embodiments, a data instance is determined to be anomalous at S215 only if the data instance belongs to the first set and to the second set. The remaining steps of process 200 then proceed as described to store the data instance in association with an anomalous or non-anomalous label.

Process 200 is performed in this manner while labeled data instances continue to be received at S935, until it is again determined to retrain the classification model at S940 Flow returns to S915 to retrain the model in response to the determination.

Flow proceeds from S925 to S955 if the performance level P of the model is determined to be greater than P2. At S955, it is determined to use the trained model only and to not use policy-based anomaly detection. In some embodiments, process 900 terminates at S955.

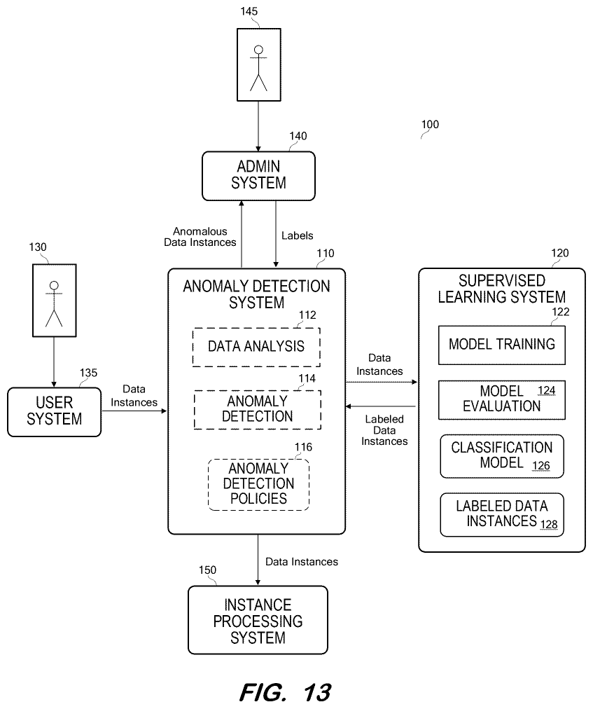

FIG. 13 illustrates operation of system 100 according to S955. As shown, anomaly detection system 110 simply passes data instances received from user system 130 to system 120. System 120 inputs the data instances to trained model 126 to determine whether the data instances are anomalous or not, and returns correspondingly-labeled data instances to system 110.

System 110 transmits the anomalous data instances to user 145 for confirmation and receives corresponding labels from system 140 as described above. System 110 then forwards the data instances labeled by model 126 or by user 145 as not anomalous to instance processing system 150. The data instances labeled by model 126 and by user 145 as anomalous are rejected.

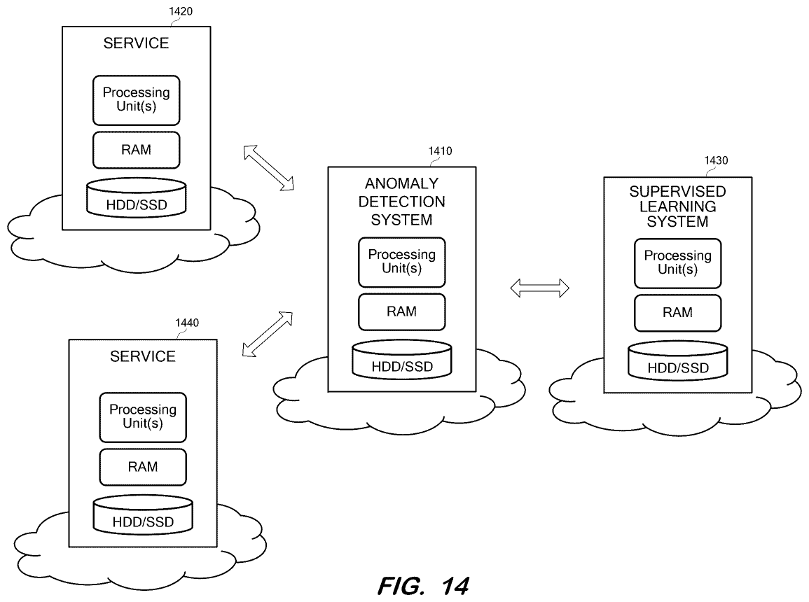

FIG. 14 illustrates a cloud-based deployment according to some embodiments. The illustrated components may comprise cloud-based compute resources residing in one or more public clouds providing self-service and immediate provisioning, autoscaling, security, compliance and identity management features. Each component may comprise servers or virtual machines of a Kubernetes cluster.

Anomaly detection system 1410 receives data instances from service 1420, performs anomaly detection on the data instances and transmits the data instances to supervised learning system 1430. Anomaly detection system 1410 may transmit data instances which were determined to be anomalous to service 1440 for confirmation by a user. Supervised learning system 1430 trains a classification model based on labeled data instances and uses the trained classification model to determine anomalous data instances.

Initially, the determinations of the trained model are used in conjunction with anomaly detection performed by anomaly detection system 1410 to determine whether to present a data instance to a user for confirmation of whether the data instance is anomalous. The model is retrained based on new data instances and, once the performance level of the trained model exceeds a particular level, only the determinations of the trained model are used to determine whether to present a data instance to a user for confirmation.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state random-access memory or read-only memory storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing processor-executable program code; and
at least one processing unit to execute the processor-executable program code to cause the system to:
receive a plurality of data instances, each of the plurality of data instances comprising a value for each of a plurality of fields and a label indicating whether the data instance is anomalous or not anomalous;
train a classification model based on the plurality of data instances;
evaluate a first performance of the trained classification model;
determine that the first performance of the trained classification model is above a first performance threshold and below a second performance threshold;
in response to the determination that the performance of the trained classification model is above the first performance threshold and below the second performance threshold:
receive a first data instance comprising a first value for each of the plurality of fields;
determine, based on anomaly detection rules, a first anomaly value indicating whether the first data instance is anomalous or not anomalous;
determine, using the trained classification model, a second anomaly value indicating whether the first data instance is anomalous or not anomalous;
determine, based on the first anomaly value and the second anomaly value, a third anomaly value indicating whether the first data instance is anomalous or not anomalous;
present the first data instance and the third anomaly value;
receive a confirmation of whether the presented first data instance is anomalous;
based on the confirmation, associate a first label with the first data instance to generate a first labeled data instance;
determine to re-train the classification model;
re-train the classification model based on the first labeled data instance;
evaluate a second performance of the re-trained classification model;
determine that the second performance of the re-trained classification model is above the second performance threshold;
in response to the determination that the performance of the trained classification model is above the second performance threshold:
determine to use the re-trained classification model and not the anomaly detection rules to determine whether a data instance is anomalous or not anomalous;
receive a second data instance comprising a second value for each of the plurality of fields;
determine, using the re-trained classification model and not the anomaly detection rules, a fourth anomaly value indicating that the second data instance is not anomalous; and
in response to the determination of the fourth anomaly value indicating that the second data instance is not anomalous, transmit the second data instance to an instance processing system.

2. The system of claim 1, the at least one processing unit to execute the processor-executable program code to cause the system to:
prior to receipt of the plurality of data instances, receive a second plurality of data instances, each of the second plurality of data instances comprising a third value for each of the plurality of fields and a label indicating whether the data instance is anomalous or not anomalous;
determine that the number of the second plurality of data instances is greater than a first instance threshold;
in response to the determination that the number is greater than the first instance threshold:
train the classification model based on the second plurality of data instances;
evaluate a third performance of the classification model trained based on the second plurality of data instances;
determine that the third performance is below the first performance threshold;
in response to the determination that the third performance is below the third performance threshold:
determine to use the anomaly detection rules and not the classification model trained based on the second plurality of data instances to determine whether a data instance is anomalous or not anomalous;
receive a third data instance comprising a fourth value for each of the plurality of fields; and
determine, using the anomaly detection rules and not the classification model trained based on the second plurality of data instances, a fifth anomaly value indicating whether the third data instance is anomalous or not anomalous.

3. The system of claim 2, the at least one processing unit to execute the processor-executable program code to cause the system to:
present the third data instance and the fifth anomaly value;
receive a confirmation of whether the presented third data instance is anomalous; and
based on the confirmation of whether the presented third data instance is anomalous, associate a third label with the third data instance to generate a third labeled data instance,
wherein the plurality of data instances based on which the classification model is trained comprises the third labeled data instance.

4. The system of claim 3, wherein the determination to re-train the classification model comprises determination that a third number of a third plurality of data instances exceeds a first instance threshold, the third plurality of data instances comprising the first labeled data instance, and each of the third plurality of data instances comprising a third value for each of the plurality of fields and a label indicating whether the data instance is anomalous or not anomalous, and
wherein re-training of the classification model comprises re-training of the classification model based on the third plurality of data instances.

5. The system of claim 1, wherein the determination to re-train the classification model comprises determination that a second number of a second plurality of data instances exceeds a first instance threshold, the second plurality of data instances comprising the first labeled data instance, and each of the second plurality of data instances comprising a third value for each of the plurality of fields and a label indicating whether the data instance is anomalous or not anomalous, and
wherein re-training of the classification model comprises re-training of the classification model based on the second plurality of data instances.

6. The system of claim 1, wherein the confirmation of whether the presented first data instance is anomalous comprises a confirmation that the presented first data instance is not anomalous, and the at least one processing unit to execute the processor-executable program code to cause the system to:
in response to the confirmation that the presented first data instance is not anomalous, transmitting the first data instance to the instance processing system.

7. The system of claim 6, wherein the instance processing system comprises a payment processing system.

8. A computer-implemented method comprising:
receiving a plurality of data instances, each of the plurality of data instances comprising a value for each of a plurality of fields and a label indicating whether the data instance is anomalous or not anomalous;
training a classification model based on the plurality of data instances;
evaluating a first performance of the trained classification model;
determining that the first performance of the trained classification model is above a first performance threshold and below a second performance threshold;
in response to determining that the performance of the trained classification model is above the first performance threshold and below the second performance threshold:
receiving a first data instance comprising a first value for each of the plurality of fields;
determining, based on anomaly detection rules, a first anomaly value indicating whether the first data instance is anomalous or not anomalous;
determining, using the trained classification model, a second anomaly value indicating whether the first data instance is anomalous or not anomalous;
determining, based on the first anomaly value and the second anomaly value, a third anomaly value indicating whether the first data instance is anomalous or not anomalous;
presenting the first data instance and the third anomaly value;
receiving a confirmation of whether the presented first data instance is anomalous;
based on the confirmation, associating a first label with the first data instance to generate a first labeled data instance;
re-training the classification model based on the first labeled data instance;
evaluating a second performance of the re-trained classification model;
determining that the second performance of the re-trained classification model is above the second performance threshold;
in response to determining that the performance of the trained classification model is above the second performance threshold:
determining to use the re-trained classification model and not the anomaly detection rules to determine whether a data instance is anomalous or not anomalous;
receiving a second data instance comprising a second value for each of the plurality of fields; and determining, using the re-trained classification model and not the anomaly detection rules, a fourth anomaly value indicating whether the second data instance is anomalous or not anomalous; and
in response to determining the fourth anomaly value indicating that the second data instance is not anomalous, transmitting the second data instance to an instance processing system.

9. The method of claim 8, further comprising:
prior to receipt of the plurality of data instances, receiving a second plurality of data instances, each of the second plurality of data instances comprising a third value for each of the plurality of fields and a label indicating whether the data instance is anomalous or not anomalous;
determining that the number of the second plurality of data instances is greater than a first instance threshold;
in response to determining that the number is greater than the first instance threshold:
training the classification model based on the second plurality of data instances;
evaluating a third performance of the classification model trained based on the second plurality of data instances;
determining that the third performance is below the first performance threshold;
in response the determining that the third performance is below the third performance threshold:
determining to use the anomaly detection rules and not the classification model trained based on the second plurality of data instances to determine whether a data instance is anomalous or not anomalous;
receiving a third data instance comprising a fourth value for each of the plurality of fields; and
determining, using the anomaly detection rules and not the classification model trained based on the second plurality of data instances, a fifth anomaly value indicating whether the third data instance is anomalous or not anomalous.

10. The method of claim 9, further comprising:
presenting the third data instance and the fifth anomaly value;
receiving a confirmation of whether the presented third data instance is anomalous; and
based on the confirmation of whether the presented third data instance is anomalous, associating a third label with the third data instance to generate a third labeled data instance,
wherein the plurality of data instances based on which the classification model is trained comprises the third labeled data instance.

11. The method of claim 10, further comprising:
determining to re-train the classification model by determining that a third number of a third plurality of data instances exceeds a first instance threshold, the third plurality of data instances comprising the first labeled data instance, and each of the third plurality of data instances comprising a third value for each of the plurality of fields and a label indicating whether the data instance is anomalous or not anomalous, and
wherein re-training the classification model comprises re-training the classification model based on the third plurality of data instances.

12. The method of claim 8, further comprising:
determining to re-train the classification model by determining to re-train the classification model comprises determining that a second number of a second plurality of data instances exceeds a first instance threshold, the second plurality of data instances comprising the first labeled data instance, and each of the second plurality of data instances comprising a third value for each of the plurality of fields and a label indicating whether the data instance is anomalous or not anomalous, and
wherein re-training the classification model comprises re-training the classification model based on the second plurality of data instances.

13. The method of claim 8, wherein the confirming whether the presented first data instance is anomalous comprises confirming that the presented first data instance is not anomalous, the method further comprising:
in response to the confirmation that the presented first data instance is not anomalous, transmit the first data instance to an instance processing system.

14. The method of claim 13, wherein the instance processing system is a payment processing system.

15. One or more computer-readable media storing program code, the program code executable by a computing system to cause the computing system to:
receive a plurality of data instances, each of the plurality of data instances comprising a value for each of a plurality of fields and a label indicating whether the data instance is anomalous or not anomalous;
train a classification model based on the plurality of data instances;
evaluate a first performance of the trained classification model;
determine that the first performance of the trained classification model is above a first performance threshold and below a second performance threshold;
in response to the determination that the performance of the trained classification model is above the first performance threshold and below the second performance threshold:
receive a first data instance comprising a first value for each of the plurality of fields;
determine, based on anomaly detection rules, a first anomaly value indicating whether the first data instance is anomalous or not anomalous;
determine, using the trained classification model, a second anomaly value indicating whether the first data instance is anomalous or not anomalous;
determine, based on the first anomaly value and the second anomaly value, a third anomaly value indicating whether the first data instance is anomalous or not anomalous;
present the first data instance and the third anomaly value;
receive a confirmation of whether the presented first data instance is anomalous;
based on the confirmation, associate a first label with the first data instance to generate a first labeled data instance;
determine to re-train the classification model;
re-train the classification model based on the first labeled data instance;
evaluate a second performance of the re-trained classification model;
determine that the second performance of the re-trained classification model is above the second performance threshold;
in response to the determination that the performance of the trained classification model is above the second performance threshold:
determine to use the re-trained classification model and not the anomaly detection rules to determine whether a data instance is anomalous or not anomalous;
receive a second data instance comprising a second value for each of the plurality of fields; and
determine, using the re-trained classification model and not the anomaly detection rules, a fourth anomaly value indicating whether the second data instance is anomalous or not anomalous; and
in response to the determination of the fourth anomaly value indicating that the second data instance is not anomalous, transmit the second data instance to an instance processing system.

16. The one or more computer-readable media of claim 15, the program code executable by the computing system to cause the computing system to:
prior to receipt of the plurality of data instances, receive a second plurality of data instances, each of the second plurality of data instances comprising a third value for each of the plurality of fields and a label indicating whether the data instance is anomalous or not anomalous;
determine that the number of the second plurality of data instances is greater than a first instance threshold;
in response to the determination that the number is greater than the first instance threshold:
train the classification model based on the second plurality of data instances;
evaluate a third performance of the classification model trained based on the second plurality of data instances;
determine that the third performance is below the first performance threshold;
in response to the determination that the third performance is below the third performance threshold:
determine to use the anomaly detection rules and not the classification model trained based on the second plurality of data instances to determine whether a data instance is anomalous or not anomalous;
receive a third data instance comprising a fourth value for each of the plurality of fields; and
determine, using the anomaly detection rules and not the classification model trained based on the second plurality of data instances, a fifth anomaly value indicating whether the third data instance is anomalous or not anomalous.

17. The one or more computer-readable media of claim 16, the program code executable by the computing system to cause the computing system to:
present the third data instance and the fifth anomaly value;
receive a confirmation of whether the presented third data instance is anomalous; and
based on the confirmation of whether the presented third data instance is anomalous, associate a third label with the third data instance to generate a third labeled data instance,
wherein the plurality of data instances based on which the classification model is trained comprises the third labeled data instance.

18. The one or more computer-readable media of claim 17, wherein the determination to re-train the classification model comprises determination that a third number of a third plurality of data instances exceeds a first instance threshold, the third plurality of data instances comprising the first labeled data instance, and each of the third plurality of data instances comprising a third value for each of the plurality of fields and a label indicating whether the data instance is anomalous or not anomalous, and
wherein re-training of the classification model comprises re-training of the classification model based on the third plurality of data instances.

19. The one or more computer-readable media of claim 15, wherein the determination to re-train the classification model comprises determination that a second number of a second plurality of data instances exceeds a first instance threshold, the second plurality of data instances comprising the first labeled data instance, and each of the second plurality of data instances comprising a third value for each of the plurality of fields and a label indicating whether the data instance is anomalous or not anomalous, and
wherein re-training of the classification model comprises re-training of the classification model based on the second plurality of data instances.

20. The one or more computer-readable media of claim 15, wherein the confirmation of whether the presented first data instance is anomalous comprises a confirmation that the presented first data instance is not anomalous, and the program code executable by the computing system to cause the computing system to:
in response to the confirmation that the presented first data instance is not anomalous, transmit the first data instance to the instance processing system.
